(19) United States
(12) Patent Application Publication
(10) Pub. No.: US 2008/0281783 A1
(43) Pub. Date: Nov. 13, 2008

(54) SYSTEM AND METHOD FOR PRESENTING MEDIA

(76) Inventors: Leon Papkoff, San Jose, CA (US); Kenny Chen, Campbell, CA (US); Conrad Rushing, San Jose, CA (US); William Kwok, San Jose, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/745,408

(22) Filed: May 7, 2007

(51) Int. Cl. G06F 17/30

(52) U.S. Cl. 707/3; 707/E17.014

(57) ABSTRACT

One embodiment of the present invention may permit retrieving and presenting media resources and/or providing online chat functionality. The embodiment may include a communication toolbar. The communication toolbar may be an interactive user tool that allows a user to retrieve and display document and media files, website/pages links, and/or conference links. The communication toolbar may also aid users in facilitating an on-line chat between one another. Another embodiment of the present invention takes the form of a media retrieval and display module that may show any and all retrieved search results to the user. Each search result may include a text description of the media record file, such as a title, a link to the media record file and a time bar associated with the media record file. The time bar may include at last one graphic indicator corresponding to a time in the media file where the search term is used.

The present invention generally relates to a system and method for presenting media to a user. More particularly, the present invention relates to a system and method for presenting media files, such as audio and/or video files.

### BACKGROUND

In general, Internet search engines retrieve search results related to media files based on a user-inputted search query. Once retrieved, a website related to the search engine displays the search results in a list. Each search result generally includes information, such as a title of the web page, a URL link, and highlighted search query terms with some surrounding text gather from the web page associated with a specific media file. When a user selects one of the search results related to a specific media file, a media-playing device displays and/or plays the selected media file without any relevance to the user-inputted search query.

There is a need in the art to provide a system and a method to present media files retrieved via a search engine in relation to a user-inputted search query.

### SUMMARY

One embodiment of the present invention may permit retrieving and presenting media resources and/or providing online chat functionality. Among other features disclosed herein, a communication toolbar may be employed to provide this functionality. The communication toolbar may be an interactive user tool that allows a user to retrieve and display document and media files, website/pages links, and/or conference links. The communication toolbar may also aid users in facilitating an on-line chat between one another.

Another embodiment of the present invention takes the form of a media retrieval and display module. The embodiment may, for example, retrieve and/or present media files to a user, or links to such media files, in response to a search request. In embodiments separating functionality between modules, the media retrieval and display module may include a synthesizing module, a search and retrieve module (herein referred to as “S/R module”), a media presentation module (herein referred to as “MP module”). The S/R module may show any and all retrieved search results to the user. Within a display pane, the S/R module may display the search results in a list. Each search result may include a text description of the media record file, such as a title, a link to the media record file and a time bar displaying a playback time associated with the media record file. The time bar may include at last one graphic indicator corresponding to a time in the media file where the search term is used.

As will be realized by those of ordinary skill in the art upon reading the entirety of this disclosure, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

The drawings described herein are for illustration purposes only and are not intended to limit the scope of the present disclosure in any way.

FIG. 1 is a block diagram of an exemplary embodiment of the present invention illustrated as a communication toolbar.

FIG. 2 is a diagrammatic view of the communication toolbar in FIG. 1 with a plurality of selectable tabs.

FIG. 3 is a diagrammatic view of the communication toolbar in FIG. 2 with an exemplary community chat tab selected that has an exemplary sign-in page.

FIG. 4 is a diagrammatic view of the communication toolbar in FIG. 3 with the chat tab selected displaying an exemplary list of users that have joined and are logged into the community and a message window for sending an invite to chat or wave.

FIG. 5 is a diagrammatic view of the communication toolbar in FIG. 3 with the chat tab selected and a message window for a chat invitation.

FIG. 6 is a diagrammatic view of the communication toolbar in FIG. 3 with the chat tab selected and an exemplary chat window.

FIG. 7 is a diagrammatic view of the communication toolbar in FIG. 3 with the chat tab selected and a message window for displaying a received wave.

FIG. 8 is a diagrammatic view of the toolbar of FIG. 2 with an exemplary search tab selected.

FIG. 9 is a diagrammatic view of the toolbar of FIG. 2 with an exemplary preferences tab selected.

FIG. 10 is a block diagram of a second exemplary embodiment of the present invention.

FIG. 11 is a diagrammatic view of an exemplary transcript of a media record file created by the synthesizing module.

FIG. 12 is a diagrammatic view of a web page of the system in FIG. 10 displaying an exemplary listing of search results.

FIG. 13 is a diagrammatic view of an exemplary media file displayed by a MP module of the system in FIG. 10.

FIG. 14 is a diagrammatic view of an exemplary time bar having a plurality of graphic indicators.

FIG. 15 is a flow chart of a method used by the system in FIG. 10.

### DETAILED DESCRIPTION OF THE VARIOUS EMBODIMENTS

One embodiment of the present invention may permit retrieving and presenting media resources and/or providing online chat functionality. Among other features disclosed herein, a communication toolbar may be employed to provide this functionality. The communication toolbar may be an interactive user tool that allows a user to retrieve and display document and media files, website/pages links, and/or conference links. The communication toolbar may also aid users in facilitating an on-line chat between one another.

Certain embodiments of the toolbar include a recommendation module, a community chat module, a search and retrieve module (herein termed “S/R module”) and a preferences module. The recommendation module may interface with a search engine to search an intranet or the Internet. The recommendation module may automatically receive, from the search engine, resources or search results, such as web pages and/or websites and/or media files based on previously selected preferences. Once retrieved, the recommendation module may present the search results to the user in a display plane. The on-line community chat module may include a chat window to enable communication via two-way typing to connect users to one another. The S/R module may communicate with the search engine and receive media files based on a user-inputted search query in order to retrieve the media files. The preferences module may include a plurality of predetermined user selectable preference options. The preferences options may include, for example, a personal profile, and/or professional interests. Among other things, the preference options may enable the recommendation module to request and retrieved web pages and/or websites and/or media files based on selected preferences. The preference option may also enable the community chat module to retrieve other users for a particular user based on selected preferences.

In use, a user may select any one of the plurality of user selectable tabs. For example, if the user selects a recommendation tab, the recommendation module may automatically retrieve and present resources based on user preferences, which may be set from the preferences tab (discussed below). The resources may include, for example, live-web conferences, media files, and/or downloads that have been retrieved by the embodiment. Once presented, the user may select at least one resource for viewing or playing.

If the user selects a community chat tab, the community chat module may allow a user to join a community to chat via text with one or more others, each of whom are typically remotely located from the user and accessed across a network. The preferences selected under the preferences tab may determine whom is visible in the chat tab to the user. For example, the embodiment may display only others also accessing a chat tab on a toolbar of their own and who also match one or more preferences of the present user.

When the user selects the search tab, the search module may allow the user to enter a search query in order to retrieve resources, such as media files, related to or matching the search query. After retrieving the resources, the search module may present the search results on the search tab to the user. By selecting a preferences tab, the preferences module may allow the user to select any one of a plurality of preferences options related to the personal profile section or professional interest section.

As used herein, the term “module” generally refers to a software or hardware solution capable of performing the features ascribed thereto. Software implementations may be programmed in any appropriate computer-executable language. A hardware implementation may take the form of an application specific integrated circuit (ASIC), electronic circuit, processor (shared, dedicated, or group) and/or memory operative to execute one or more software or firmware programs, combinational logic circuit, or other suitable components.

The embodiments described herein may run on any type of computer or computing device including, but not limited to, game machines. Other computing devices, on which the embodiments may run or execute on include mobile phones, personal digital assistants, mobile computing devices, laptops, desktops, and distributing computing architectures, etc.

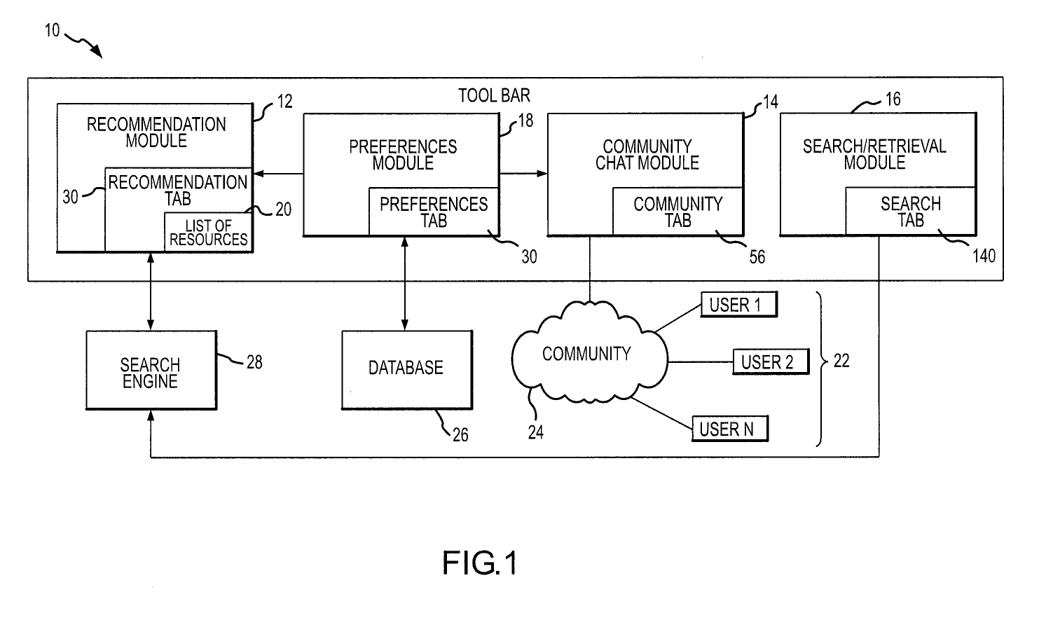

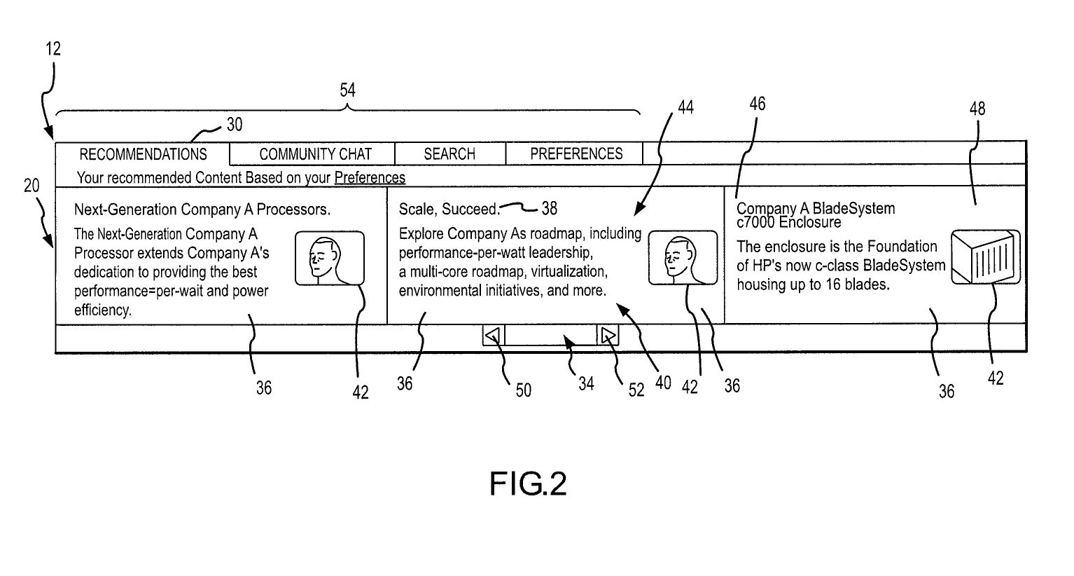

FIG. 1 is a block diagram of an exemplary embodiment of the present invention illustrated as a communication toolbar. FIG. 2 is a diagrammatic view of the communication toolbar 10 in FIG. 1 with a recommendation tab selected.

Referring to FIG. 1, a communication toolbar 10 may include an application that may be layered over an existing web-interface program or standard for delivering high-impact, feature-rich Web content. The toolbar 10 may include, for example, a Flash application. The web-interface standard may include user interfaces for designs, animation, or application that may be usable with any browsers including, for example, a Flash site. Although the toolbar 10 of the present embodiment may be integrated into an existing web-interface application, in alternative embodiments the toolbar may operate independently and/or stand alone from other applications.

As shown in FIG. 1, the communication toolbar 10 may include a recommendation module 12, a community chat module 14, a S/R module 16, and a preferences module 18. The recommendation module 12 may retrieve and display a list of resources 20 based on user selected preferences, while the chat module 14 may allow a user to communicate with other users 22 of a community 24. The community chat module 14 may restrict the communication between a user and other users 22 based on user-selected preferences or automatically set preferences. The S/R module 16 may allow a user to search the Internet, an intranet, or a single web site using keywords or a search query. Additionally, the S/R module 16 may display search results or retrieved resources 20. The preferences module 18 may allow a user to select and edit any one of a list of predetermined preferences. The user-selected preferences may be stored in a database 26 and retrieved when needed by the recommendation module 12 and/or the chat module 14.

Referring to FIG. 1, the recommendation module 12 is in communication with a search engine 28. The recommendation module 12 may automatically request a search based on user selectable preferences from the search engine 28. After the search engine 28 retrieves the search results or recommendation items, the recommendation module 12 may present the recommendation items to the user. Searching and display of media resources by various embodiments of the present invention is discussed in more detail below.

Now referring to FIGS. 1-2, the recommendation module 12 may include a recommendation tab 30 displayed on the toolbar 10. The recommendation tab 30 may be set as a default tab. As shown in FIG. 2, the recommendation tab 30 may include a display area 32 and a scroll bar 34. The display area 32 may include an area used to display the recommendation items or resources 20. The display area 32 may include a plurality of display panes 36 or one display pane divided into a plurality of display sections 36. Each display plane 36a may display at least one recommended item. The scroll bar 34 may include a graphical device used to change a user's view of the recommendation items located in the display pane.

Referring to FIG. 2, a recommended item 20 may include at least one of a web-conference, a media file, or an audio or video download. The web conference may include a live meeting or presentation over the Internet or Intranet, such as, for example, a “webinar” (e.g., a seminar presented on or across the World Wide Web, either live or pre-recorded). The webinar may include a Web conference or a presentation that is given primarily one way from the presenter to the audience. The webinar may also include a Web conference or presentation given in an interactive two-way between a presenter and the audience. Each recommendation item 20 may also include a title 38, a description 40, and thumbnail image 42 that represents the recommendation item. For example, as illustrated in FIG. 2, a recommendation item may include the title 38 located at a top 44 of the display pane 36, the description 40 located on a first or left side 46 of the display pane 36, and the thumbnail image 42 located on a right side 48 of the display pane 36.

Items appearing in the recommendation tab 30 may be automatically chosen by the present embodiment based on one or more factors, including user-specified preferences, recommendations or other content previously accessed by a user through the embodiment, or items specified by an administrator of the embodiment.

Still referring to FIG. 2, the scroll bar 34 may be located beneath the display plane. Alternatively, the scroll bar 34 may be located anywhere about or within the recommendation tab 30. The scroll bar 34 may include a first scroll arrow 50 and a second scroll arrow 52. The view of the recommendation items 20 by a user pressing on one of the scroll arrows 50, 52. These actions cause the view in the display pane 36 to scroll in a sideways direction such as in a right direction or a left direction in the display area 32 above the scroll bar 34.

In use, a user may select any one of a plurality of tabs 54 listed on the toolbar 10. For example, if the user selects the recommendation tab 30, the recommendation tab 30 may be displayed in the toolbar 10. (Generally, although not necessarily, only one expanded tab is displayed in the toolbar 10 at any given time, although the smaller selection icons for each tab are typically always accessible.) A list of recommended resources 20 may be displayed in the display area 32. The recommendation module 12 receives the list of recommended resources 20 based on the user-selected preferences. Using the scroll bar 34, the user may scroll the list of recommended resources 20. The user may select one of the recommended resources 20. If the user selects a recommended resource, such as a webinar, the recommendation module 12 may bring the user to a webinar booth and launch the webinar. If the user selects a recommended resource, such as a media file, the recommendation module 12 may bring the user to a partner booth and launch the media file. If the user selects a recommendation resource, such as a download file, the recommendation module may send the download file to a partner booth and save the file to the communication toolbar 10.

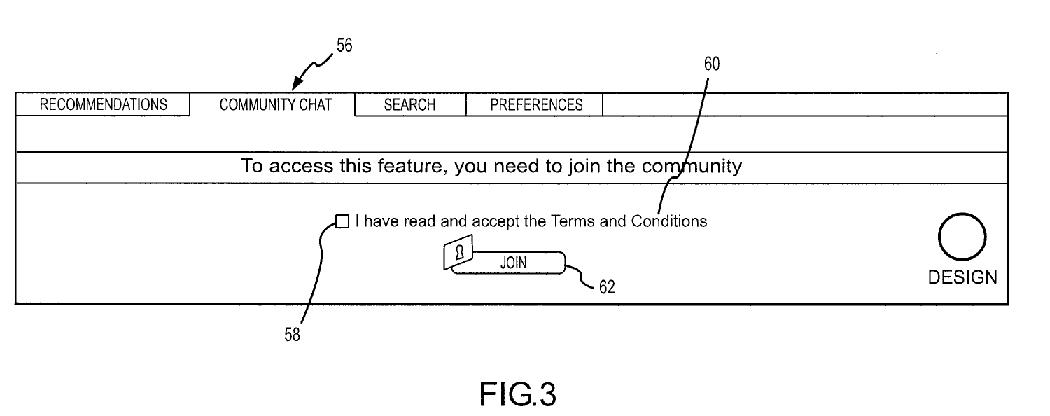

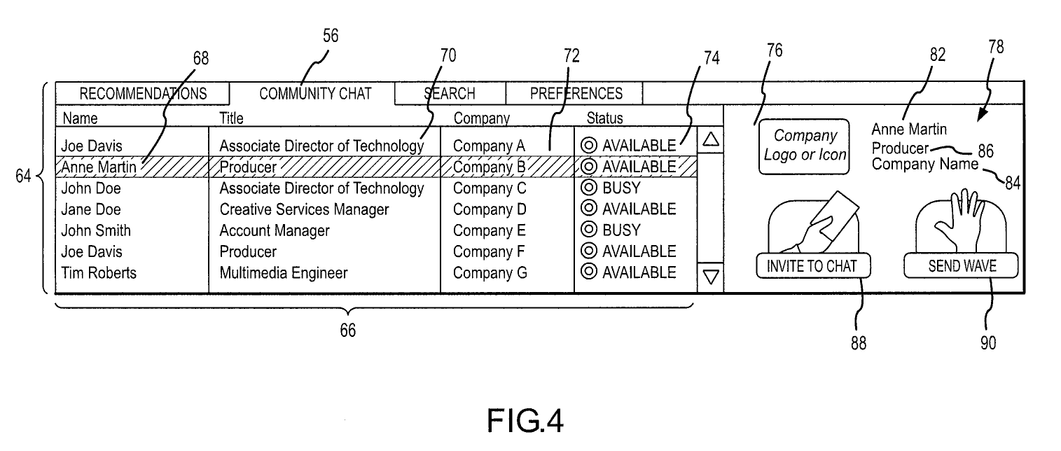

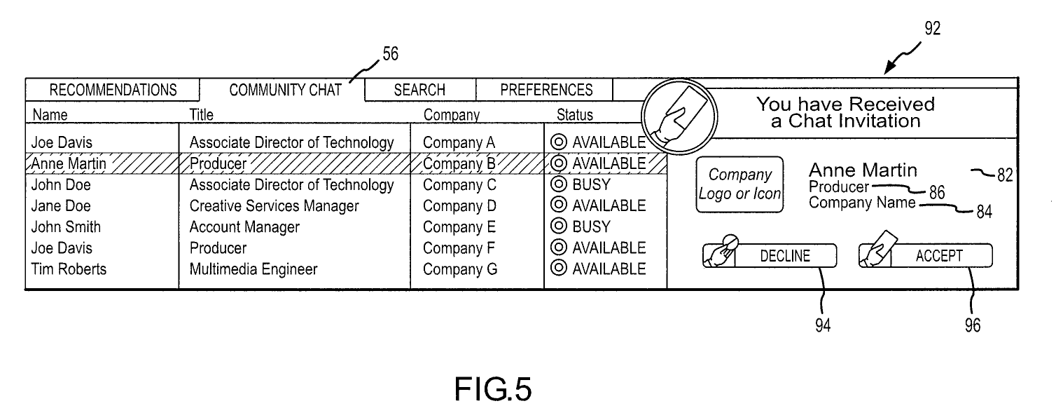

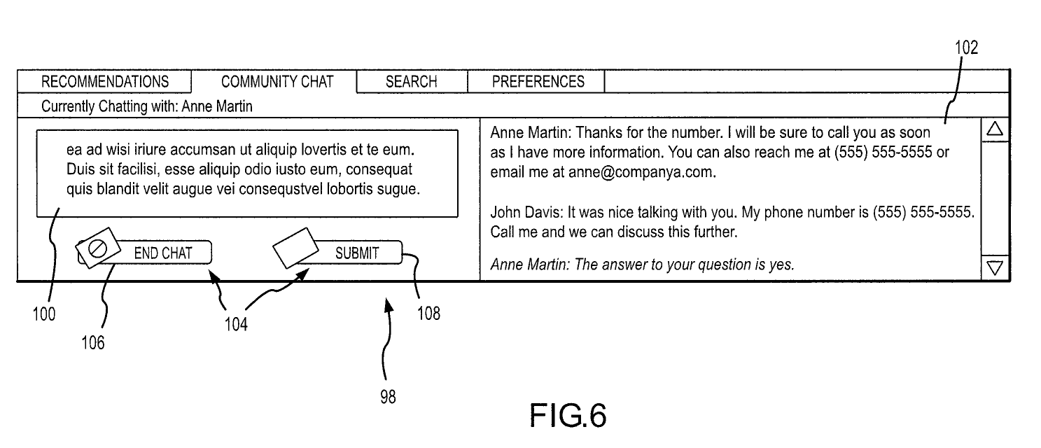

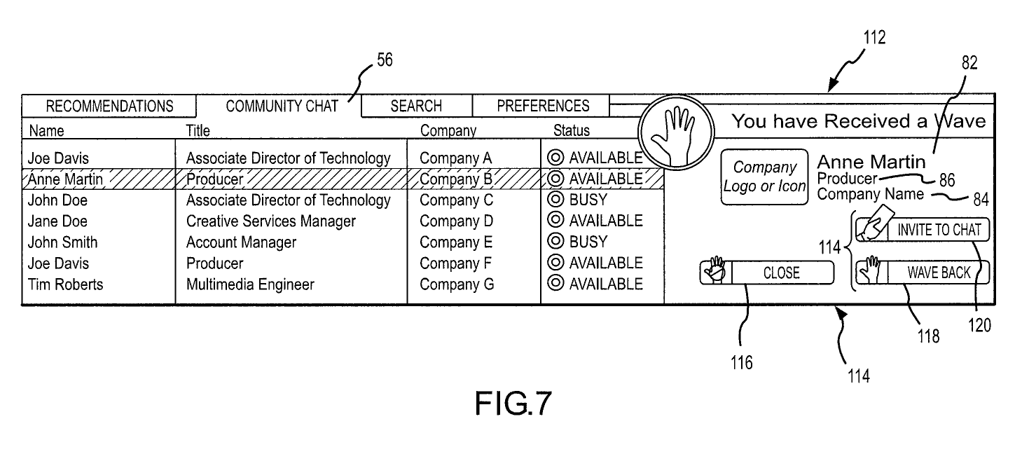

FIG. 3 is a diagrammatic view of the communication toolbar 10 in FIG. 2 with a community chat tab selected. This view also provides an exemplary sign-in page. FIG. 4 is a diagrammatic view of the communication toolbar 10 in FIG. 3 with the chat tab selected. The community chat tab is shown with a display pane presenting an exemplary list of users that have joined and are logged into the community 24. In the diagrammatic view of FIG. 4, an exemplary message window with sending an invite to chat or wave is also provided. FIG. 5 is a diagrammatic view of the communication toolbar 10 in FIG. 3 with the chat tab selected. In this view, a message window for a chat invitation is also shown. FIG. 6 is a diagrammatic view of the communication toolbar 10 in FIG. 3 with the chat tab selected. In this view, an exemplary chat window is also illustrated. The chat window also includes an exemplary chat interactive dialog box and an exemplary viewing box. FIG. 7 is a diagrammatic view of the communication toolbar in FIG. 3 with the chat tab selected and an exemplary message window displaying a received wave.

Returning to FIG. 1, the community chat module 14 may allow a user of the toolbar 10 to communicate with other users 22 of the community 24. The community chat module 14 is in communication with the community 24. Additionally, other users 22 may also access the community 24 with whom the user may be able to communicate via the community chat module 14.

Now referring to FIGS. 1 and 3, a user may join and login into the community chat module 14 in order to access the community 24. One step to access the community 24 may include agreeing to terms and conditions associated with a community chat tab 56. As illustrated in FIG. 3, located within the community tab 56 may be a terms and conditions checkbox 58, a terms and conditions link 60, a join button 62, and an automatic login checkbox 64. The terms and conditions checkbox 58 may be a required checkbox, such that if the checkbox is not selected, the community chat module 14 may prevent a user from accessing the community 24. When the user selects the terms and conditions link 60, a popup window, for example, a HTML popup window, may be launched. The popup window may include text and/or related images describing features of the community 24. The join button 62 may be pressed by a user to join the community 24. If a user is not a registered user, the community chat module 14 may initiate a registration protocol. The user's registration data may be stored the communication toolbar 10, as shown in FIG. 1. Once a user has registered, the user may be logged into the community 24.

Referring again to FIG. 3, the automatic login checkbox 58 may be an optional checkbox that, if checked, produces an automatic check-in feature that automatically allows a registered user to login into the community 24 once the community tab 56 is selected. By default, the automatic login checkbox 58 may be selected. The checkbox 58, however, may be changed in the preferences module 18. If either a user fails to check in by either the automatic check feature 58 or by pressing the join button 62, the community chat module 14 may present the user with an error message. The error message may be precise in that it may explain any problems encountered.

Referring to FIGS. 4-5, the community tab 56 may include a list of other users 64 that have joined and are logged into the community 24. Each user displayed in the list 64 may include user information 66. The user information 68 may include, for example, a user name 68, a job title 70, a company name 72, and a status 74. The user name 68 may include identification of a user. The job title 70 may include a general description that explains a job function of a person. The status 74 may indicate whether a particular user is available for communication. For example, the status 74 may state available or busy. The status 74 available may indicate that a user is available for chats and/or waves. The status busy may indicate that a user is available for waves, but unavailable for chats.

Although the user information 66 may be listed in any order and manner, the user information 66 may be listed in columns vertically across a display pane 76. The user information 66 may be sorted by alphabetical order and/or weight. For example, the user information 66 may be sorted by a user clicking on a respective column heading (e.g. user name, job title, company name, or status). The users 64 listed may be selected based on the previously selected preferences. For example, the community tab 56 may only display other users 64 that match the user's professional interests.

Referring to FIG. 4, when an individual user on the user's list 66 is selected, a user profile 78 associated with the individual user and communication options 80 are presented. The user profile 78 may include a description of the individual user. For example, the user profile 78 may include a user name 82, a company name 84, and/or job title 86. The communication options 80 may include options to initiate a communication with the individual user. For example, the communication options 80 may include an invite to chat 88 or a send wave 90 as shown in FIG. 4.

Chat may include a two-way typing communication between users. Chats may be conducted on a one-on-one basis or on a one-to-many bases. Referring still to FIG. 4, a user may invite another user to a chat by pressing the invite to chat option 88. By pressing the invite to chat option 88, the selected user may receive an invitation window 92, such as a popup window, to notify them of the invite to chat by an initiating user. The invite to chat option 88 may only be available to chat with other users based on the previously selected preferences. For example, the invite to chat option 88 may only be available to chat with other users that match the initiating user's professional interests.

Referring to FIG. 5, if the user is invited to a chat, the invitation window 92 may popup notifying them of the invite. An invitation may only be available with another user with a status set to available. The display pane 76 may also include a decline option 94 and an accept option 96. The decline option 94 may indicate that the selected or invited declines the invitation to chat with the initiated user. If the decline option 94 is selected, the invitation window 92 may close. The initiated user may be notified that the selected user may be busy. This notification may not change the selected user's status. The accept option 96 may indicate that the selected user accepts the invitation to chat. If the accept option 96 is selected, the invitation window 92 may close and a chat window may open.

The chat window 98 is illustrated in FIG. 6. The chat window 98 may allow a user to send typed messages and receive typed messages. The chat window may 98 include an interactive display pane 100 and a chat area display pane 102. The chat module 14 may allow a user to type messages into the pane 100 to transmit to another user. The chat area display pane 102 may be updated as with new messages sent between the initiated user and the selected user.

Still referring to FIG. 6, the chat window 98 may also include a plurality of options 104 to foster chatting. For example, the plurality of options 104 may include an end chat option 106 and a submit chat option 108. The end chat option 106 may indicate that a user is ending the chat. If the end chat option 106 is selected, the chat window 98 may be closed, and the chat session ends. The submit option 108 may indicate that a user is sending a new message. If a user selects the submit option 108, the chat area display pane 102 is updated with the new message and the new message may be sent to another user or chat partner. Although the plurality of options 104 may be located anywhere within this portion of the community tab 56, the plurality of options 104 may be located beneath interactive display pane 104, as shown in FIG. 6.

In use, a user may select the community chat tab 56 to initiate communication with other users in the community 24. The user may join the community 24 by logging into the community chat module 14. The user may click the checkbox 58 associated with the agreement to the terms and conditions of the use of the community 24. Once the checkbox 58 is selected, the user may join the community 24. If the user is a registered user, the community chat module 14 may automatically join the user to the community 24 or the user may press the join button 62 to instruct the chat module 14 to join the user to the community 24. If the user is not a registered user, the user may register then join the community 24.

Once the user is registered and joined in the community 24, the community chat tab 56 may display a list of other users 64 that may be available for communication based on the status 74 of a particular user. An invitee user may select one of the other users 64 listed in the display pane 76 and select either the invite to chat option 88 or the wave option 90. If the invitee user selects the chat option 88, a selected user may receive a message window 92 indicating that the selected user has received a chat invitation. The selected user may decline or accept the chat invitation. If the selected user presses the decline button 94, the message window 92 closes and the invitee user receives a message indicating that the selected user is busy. On the other hand, if the selected user presses the accept button 96, the message window 92 may close and the chat window open 98. The chat window 98 operates as a conventional chat window, and the selected user and the invitee user may be a typing communication between each other.

Referring again to FIGS. 4 and 7, waves may include a one-way communication from the invitee user to the selected user. Waves may only be available to a select user that has the status 74 set to either available or busy. A wave may only be available to other users based on the initiating user's previously selected preferences. For example, the initiating user may only wave to other users that match their professional interests. If the invitee user selects a user and the send wave option 90, a wave message window 112 may popup to notify the selected user of the wave, as shown in FIG. 7.

Still referring to FIG. 7, the wave message window 112 may display a message indicating that the selected user has received a wave message. The wave message window 112 may also include a plurality of options 114. The plurality of options 114 may include options that allow a user to response to an opening of the wave message window 112. For example, the wave message window 112 may include a close option 116, a wave back option 118, and/or an invite to chat option 120. If the selected user chooses the close option 116, the wave window 112 may close. If the selected user chooses the wave back option 118, the wave window 112 may close and a wave is sent back to the initiating user. If the selected user selects the invite to chat option 120, the wave window 112 may close and a chat window 98 may open. The wave window 112 may also automatically close after a predetermined period. For example, the wave window 112 may close after a period of 5 seconds.

A user may receive a queue of waves while the chat window 98 is active. If the wave windows 112 are left untouched, the most recent wave may be seen. It may fade away after the predetermine period has expired. After this wave goes away, a next recent wave may appear, and will go away in a similar fashion. This process may continue until each wave in the queue of waves or a last wave in the queue of waves is exhausted. On the other hand, if the user interacts with the wave window 112 (e.g. waving back or closing the window), the next recent wave may appear, until the last wave in the queue of waves is exhausted. In order to prevent massive waves, a user may wave at a specific person a predetermined number of times per a period. For example, a user may only wave to the specific person once per minute. If the user tries to wave to the specific person more than the predetermined number of times per the period, the user may receive an error message. The error message may be a generic error message or a detailed error message explaining the problem.

In use, the invitee user may select the send wave option 90 to have the chat module 14 send a wave. Once the invitee user presses the send wave button 90, the selected user may receive a popup window 112 indicating that the selected user has received a wave. If the selected user presses the close button 116, the wave window 112 may close. If the selected user presses the wave back button 118, the wave window may close, and the invitee user may receive a message popup window with a wave. If the selected user presses the invite to chat button 120, the wave message window may close, and the chat window 98 may open.

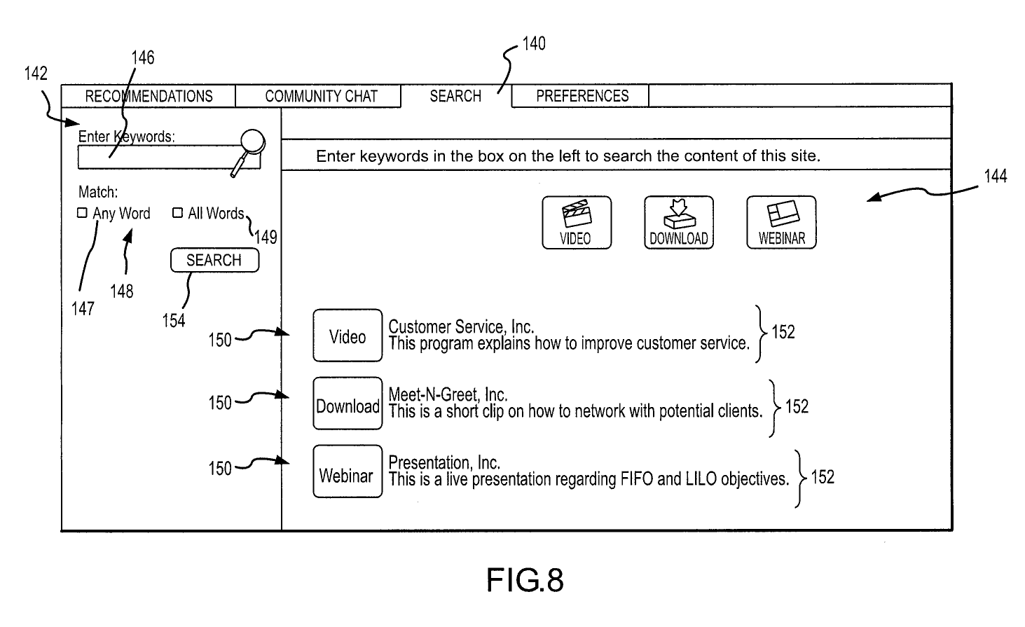

The S/R module 16 will now be discussed. FIG. 8 is a diagrammatic view of the toolbar 10 with a search tab selected.

Referring to FIG. 8, the S/R module 16 may allow a user to search for resources 20 in the Intranet or Internet environment. The S/R module 16 may include a search tab 140. The search tab 140 may include a first display pane 142 and a second display pane 144. The first display pane 142 may include a search box 146 and a plurality of options 148 to aid in conducting the search. The search box 146 may allow a user to input keywords or a search query. The search query may be used to conduct a search for resources 150 related to the search query. The search box 146 may be a textual field, with a maximum length of characters. For example, the maximum length of character may include 100 characters.

Still referring to FIG. 8, the plurality of options 148 may include, for example, a match any word option 147 and a match all words option 149. The match any word option 147 may indicate that resources 150 should be retrieved based on any word in a search query. The match all word option 149 may indicate that resources 150 should be retrieved only if all the words in the search query are found within the resource.

The S/R module 16 interacts with a conventional search engine 28 to retrieve search results or resources 150. Once the S/R module 16 receives the search results 150, the S/R module 16 may display the search results 150 on the search tab 140. More specifically, the search results 150 may be displayed in the second display pane 144 of the search tab 140. The S/R module 16 may sort the search results 150 by relevance. Additionally, each search result may include search information 152. Search information 152 may identify a specific search result from another search result. For example, each search result may include a description, a partner name, and/or an icon.

In use, if a user wants to search the Internet or intranet, the user may select the search tab 140. In the search box 146, the user may enter keywords or a search query and press an associated search button 154. The S/R module 16 may receive a message via the search button 154 and communicate with the search engine 28 to retrieve resources 20 based on the search query. The search engine 28 may include any conventional search engine. The search engine 28 may retrieve and send resources 20 based on the search query to the S/R module 16. The S/R module 16 may display retrieved resources 20 in the display pane of the search tab. The user may select at least one of the retrieved resources 150 for viewing and/or listen.

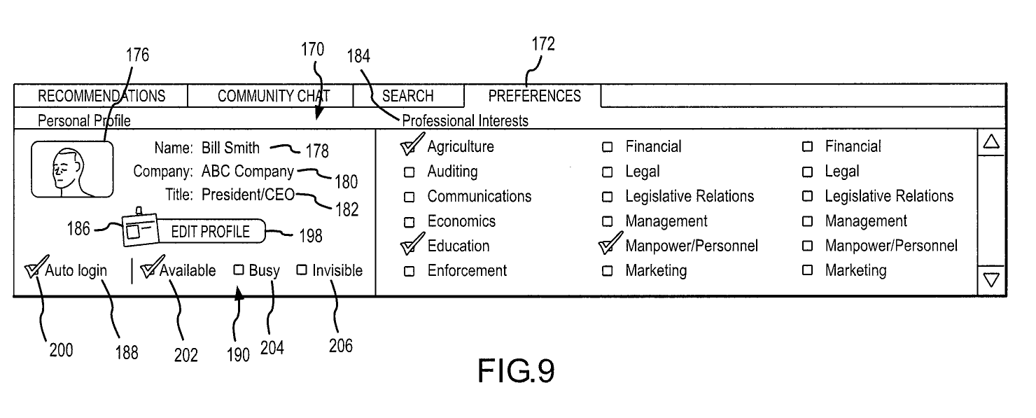

Now the description of the preferences module 18 will be discussed. FIG. 9 is a diagrammatic view of the toolbar 10 of FIG. 2 with an exemplary preferences tab selected.

Referring to FIG. 1, the preferences module 18 is in communication with the recommendation module 12 and the community chat module 14. The preferences module 18 may include a list of user selected preferences 170, which may be used by the recommendation module 12 to retrieve and display resources 20 and the community chat module 14 to restrict communication of a user to other users based on the user selected preferences.

Referring to FIGS. 1 and 9, the preferences module 18 may include a preferences tab 172. The preferences tab 172 may include a plurality of fields 174 to enable a user to utilize the toolbar 10 and related functions. The fields 174, for example, may include an icon 176, a name 178, a company 180, a job title 182, professional interests 184, edit profile 186, automatically sign in checkbox 188, and status 190. The icon 176 may include a company logo for users registered based on their company names. The name 178 may include a textual field, which may be pre-populated by a registration communication toolbar. The company name 180 may be a textual field, which may be pre-populated from the registration communication toolbar.

Still referring to FIG. 9, the professional interests 184 may provide a user with a plurality of selectable options. Some of the plurality of options may aid in automatically retrieving resources 20 to be received and displayed by the recommendation module 12. Other options may aid in determining which registered users that may be communicated to via the community chat module 14. The plurality of options may be changed at any time, by selecting the preferences tab 172 and any available options. The plurality of options 184 may include, for example, a plurality of personal interests, such as auditing, legal, financial, etc. Each option may include a checkbox 196. Some options may be pre-checked based on another field within the preferences tab, such as job title. A user may select as many options that apply to the user. Upon checking, selected or checked options 184 may be stored in the communication toolbar of the preferences module 18.

The edit profile 186 field may include a button 198 that launches the registration for the toolbar 10 a parent site. The automatically sign-in field 188 may include an optional checkbox 200. A default state of this field is checked. The status 190 may be an optional drop-down menu, from which the user may select the status. The status 190 may include the available option 202, the busy option 204, or the invisible option 206. If the available option 202 is selected, this indicates that the user is available for chats or waves. More specifically, the user's name may appear in the list of users 64 displayed on the community tab 56. This allows other users to send chats messages or waves to this user. The busy option 204 may indicate that a user is available for waves, but unavailable for chats. The invisible option 206 may prevent a user from being seen in the community 24. The user may be unavailable for waves and chats. Likewise, if a user selects the invisible status 206, the user may not be able to send chats messages or waves.

In use, a user may select the preferences tab 172 when either preferences may be selected for the first time or to modify or change previously selected preferences. In the field of professional interests 184, the user may select or deselect any of the options that apply or do not apply to the user. The user may also select to edit profile 186 of the user. The user may also select to change the status 190 to any one of the available statuses. The user may also select or deselect the checkbox 188 for the automatic sign me in field.

Another embodiment of the present invention takes the form of a media retrieval and display module (or modules). The embodiment may, for example, retrieve and/or present media files to a user, or links to such media files, in response to a search request. In embodiments separating functionality between modules, the media retrieval and display module may include a synthesizing module, a search and retrieve module (herein referred to as “S/R module”), a media presentation module (herein referred to as “MP module”).

The synthesizing module may receive media files from a search engine in order to combine text files to the media files as headers to form media record files. A text file generally may be a transcript of the media file. In combining the media file and the text file, the synthesizing module may synchronize the text file to the media file such that as a search term is found within the text file a corresponding graphic indicator may indicate the location of the search term on the time bar.

Broadly, the S/R module may utilize a user-inputted search query to initiate a search request for media files related to, or matching, the user-inputted search query. In short, the S/R module may retrieve at least one search result based on at least one search term. The S/R module may show any and all retrieved search results to the user. Within a display pane, the S/R module may display the search results in a list. Each search result may include a text description of the media record file, such as a title, a link to the media record file and a time bar displaying a playback time associated with the media record file. The text description may double as the aforementioned link.

The time bar may include at last one graphic indicator corresponding to a time in the media file where the search term is used. For example, the search term may correspond to a point in a video where the term is spoken or otherwise audible. A graphical indicator may include a symbol that points to a time location in playback time where a search term is found in a media file. As discussed in more detail below, selecting, clicking on, or otherwise interacting with the graphic indicator may cause the media file to jump to the corresponding time in the media record file and, optionally, play the media from that time.

Once a user selects at least one search result from the list of search results, the S/R module may activate the MP module to play the media record file associated with the search result. The MP module may display the selected media record file along with an associated tool bar similar to that mentioned above. The MP module may begin playing the media in a window separate from the search list once the media record file is retrieved. Further, if a graphic indicator on the time bar is selected, the MP module may advance playback of the media to the time corresponding to the selected graphic indicator.

Having generally described this embodiment, a more particular discussion of the embodiment and its properties follows.

The embodiment may accept a search term specified by a user. Upon receipt of the search term, the S/R module may conduct a search of available headers of media record files and/or an index of terms using conventionally-known search techniques to search the database and retrieve media record files related to the at least one search term. The S/R module may receive at least one search result. The S/R module may display the received search results in a list format. Each received search result generally is shown with an associated time bar; the associated time bar may graphically illustrate the length of the media file in units of time (e.g., seconds, minutes, hours) and one or more graphic indicators in the time bar.

When a user selects a search result, the S/R module may signal the MP module to retrieve and display the media record file associated with the selected search result. When loading the media record file, the header of the media record file may be loaded prior to the media portion of the file. This allows the time bar to quickly update and display graphic indicators while the media portion is loading. The MP module displays the media record file and time bar with associated graphic indicators. When the user selects any graphic indicator on the time bar, the MP module jumps or skips the media record file to the time corresponding to the graphic indicator.

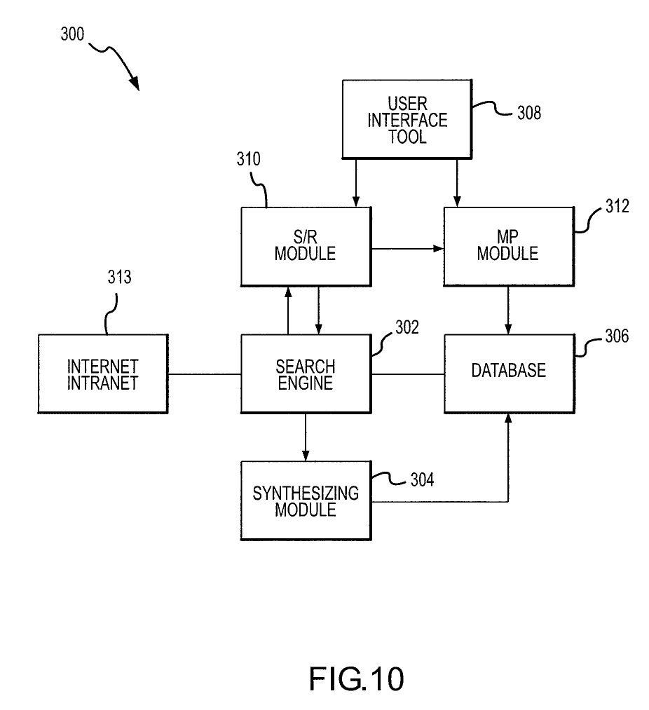

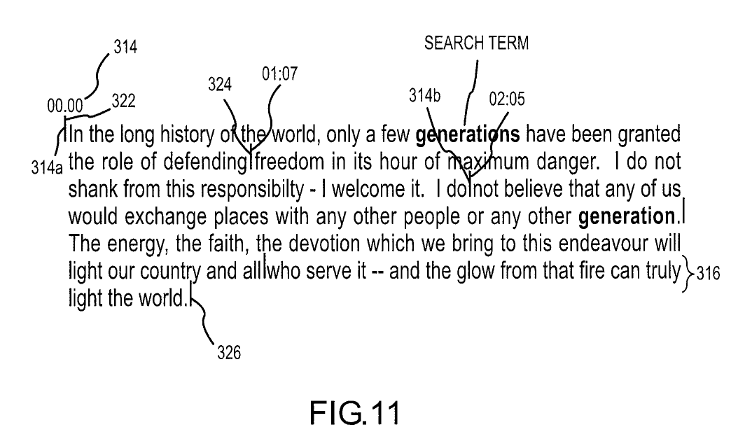

FIG. 10 is a block diagram of an exemplary embodiment that presents media files to a user. FIG. 11 is a diagrammatic view of an exemplary fragmented portion of a transcript associated with a media record file created by the synthesizing module. The transcript also includes time entries.

As shown in FIG. 10, the embodiment 300 may include a search engine 302, a synthesizing module 304, a database 306, a user interface tool 308, a S/R module 310, and a MP module 312. The search engine 302 is in communication with the synthesizing module 304 and the database 306. The user interface tool 308 is in communication with the S/R module 310, which in turn is in communication with the search engine 302 and the MP module 312. The MP module 312 is also in communication with the database 306.

The search engine 302 may operate in a manner like that of a conventional search engine 302, insofar as it may index various media files (or transcripts of files, or data/meta elements associated with such files) as records in one or a plurality of indexes and then search the indexes in response to a search query. The search engine 302 may include one or more software robots, such as a spider(s), to crawl the Internet and/or Intranet to build lists of words associated with the media files. In order to build the lists, the spiders crawl many web pages. The spiders may begin crawling at a popular website, indexing the media files and information related to the media files on its pages, and following every link found within the website. This allows the spider to quickly travel and spread across the most widely used portions of the Internet and/or Intranet. The spiders may index the information related to the media files based on words in a title of a web page, a subtitle of the web page, meta elements associated with the web page or a specific media file, an associated transcript file, and/or closed captions of a media file.

Meta elements may correspond to information about a given web page or media file. Meta elements may include meta data and meta tags. Meta data may refer to any data used to aid in the identification, description, and/or location of network electronic resources 20. Meta tags may refer to information placed in a web page not intended for users to see, but instead typically passes information to spiders, browser software, and other applications. Meta elements may be inserted into a Hypertext Markup Language code in the web page, encoded within a media file, or a combination of both, but may not be visible to a user looking at the web page or the media file.

Once the information is indexed by the spiders, the search engine 302 may store the index in the database 306. The indexed information of media files may include a list of media files, a location of each media file, and a media file identifier. Information related to the location of each media file may include a database address or a URL link. The search engine 302 may also send a copy of each media file, found by the spiders, to the synthesizing module 304 and/or S/R module 310.

Additionally, the spiders may also create an index of media record files stored in the database 306 by the synthesizing module 304. A “media record file” as used herein is generally consists of a text file and a media file. Although in the present embodiment the text file is appended to the media file as a header, in alternative embodiments the text file may be associated to the media file in any manner. The spiders of the search engine 302 may also index the text files in any conventional way in which text files are indexed by any conventional search engine 302. For example, the spiders may compile an indexed of information for the header of the media record file. This indexed information may include a list of words in the header and a location of each word in the header. The search engine 302 may also store these indexes in the database 306.

The search engine 302 may also retrieve related information regarding the media record files or search results based on a user-inputted search query. Once a search term is found in a specific media file, the search engine 302 may locate a nearest time mark that occurs prior to the search term and generates a graphic indicator on the time bar to correspond to this time mark. The search engine 302 may conduct this process of generating graphic indicators for the time bar for each search term located within the text file.

The search engine 302 may output the search results to the S/R module 310 using any conventional Internet search priority scheme for listing search results. For example, the search results may be listed in descending order based on a number of times a search term is found within each text portion of the media record file. Thus, the media record file with a highest number of search terms found in its associated text portion is listed first, and the media record file with the least number of search terms found in its associated text file is listed last.

Referring to FIG. 10, the synthesizing module 304 receives media files from the search engine 302 or a spider and combines associated text files with the media files as headers, thereby forming media record files. More specifically, the synthesizing module 304 may receive media files and examine each media file to determine if the media file includes an associated text file or other form of index. The text file typically is a transcript of the media file. If a received media file does not include an associated text file or is not associated with an existing text file, the synthesizing module 304 may transcribe the media file and thereby produce a text file or transcript. Alternatively, a human individual may physically transcribe the media file then send the media file and the text file to the synthesizing module 304, effectively fulfilling the role of the synthesizing module 304. Accordingly, it should be understood that the synthesizing module 304 is optional and its operations may be duplicated or performed by a person utilizing appropriate computing devices.

Another alternative may take the form of using speech to text technology to transcribe a media file, then sending the media file and the text file to the synthesizing module 304.

Referring to FIGS. 10-11, once the synthesizing module 304 can access both a media and an associated text file, it may record a time mark 314 for a block of characters 316 in the text file or transcript. A time mark 314 may correspond to a time stamp or any other indicator that matches up a search term to a graphical indicator on a time bar associated with a media record file. Additionally, the synthesizing module 304 may combine the transcript or text file, as a header, with the media file thereby forming a single media record file. As the transcript is combined to the media file, the synthesizing module 304 may synchronize the text file to the media file, such that as each word in the text file may be located within the playback time of the media file. In short, when a search term is found within a text file, the location of the search term corresponds to a time location within playback of the media file. This time location may be identified by a graphic indicator 318. Alternatively, this process of aiding time marks 314 may be manually done by an individual.

Referring to FIG. 11, one exemplary text fragment 313, including exemplary time marks, is shown. To generate such a file, the synthesizing module 304 may assign a first time mark 322 at the beginning of a transcript 320. From the first time mark 322, the synthesizing module 304 may counts a predetermined number of characters 316 in the text (e.g. 80 characters) and assigns another or second time mark 324 to this block of characters 316. Additionally, the predetermined number of character 316 may vary depending on the text file and/or the media file. The synthesizing module 304 repeats this counting and assigning of time marks 314 until it reaches an end 326 of the transcript 320. In another example, the synthesizing module 304 may time stamp each word within the transcript thereby indicates an instance or a location in the playback time of where the word is mentioned in the media file. Each time mark in the transcript/text file corresponds to the time in the media file at which the word or sound immediately following the time mark occurs. Essentially, the time mark synchronizes the text file to the media file. In the case of an embodiment employing speech-to-text technology to transcribe a media file's audio into a transcript, the embodiment may routinely check the playback time of the media file and add time marks accordingly. (e.g., after a given time interval such as ten seconds, a given number of characters or words, and so forth). In embodiments that do not employ speech-to-text technology, time marks may be added by an operator, estimated by the embodiment, or entered in any other suitable manner.

The database 306 may store, among other things, one or more indexes related to media files, one or more indexes related to media record files, and one or more media record files. The database 306 may include a single database or a plurality of databases. The indexes may be created, stored, and accessed by the search engine 302. The media record files may be created and stored in the database 306 by the synthesizing module 304. The media files may be received from the database 306 by the MP module 312.

Referring again to FIG. 10, the user interface tool 308 generally allows a user to input a search query into the S/R module 310. The user interface tool 308 may allow a user to select at least one of a plurality of search results retrieved by the search engine 302. In another embodiment, the user interface tool 308 may allow a user to activate and deactivate the time bar. The user interface tool 308 may take the form of, for example, a mouse, keyboard, or any other device commonly used by a user to input a search query into the S/R module 310 or interact with the MP module 312. The search query may include one or more terms or keywords used by the embodiment to conduct a search and thereby retrieve search results related to or based on the user-inputted terms or keywords.

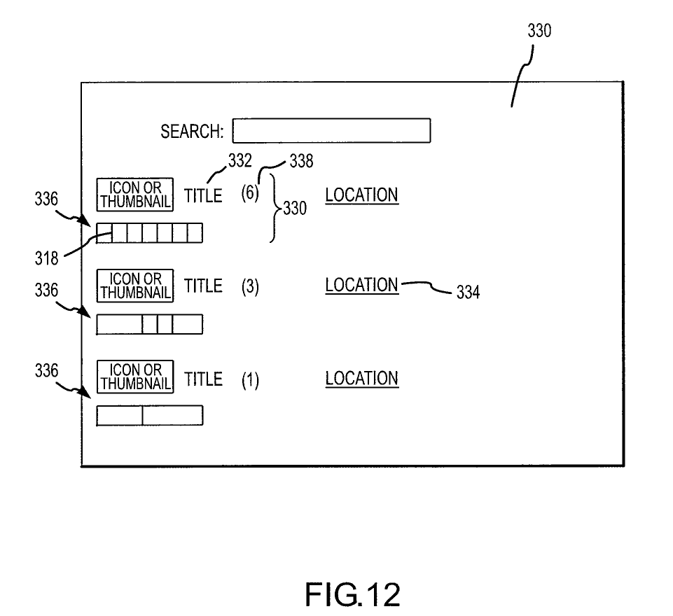

FIG. 12 is a diagrammatic view of an exemplary web page, which includes search results retrieved from the system of FIG. 1.

Referring to FIGS. 10 and 12, the S/R module 310 may initiate a search request by passing the user-inputted search query to the search engine 302. Based on the user-inputted search query, the search S/R module 310 receives search results related to media record files from the search engine 302. Search results 328 take the form of media record files. Media record files may include media files with its associated transcript or text as a header. Media files include audio, audiovisual, and/or video files. For example, the media files may include files related to Flash Video, Moving Picture Experts Group—Audio Layer 3, REAL media files, Windows Player compatible, QuickTime, Advance Audio Coding, etc.

Still referring to FIG. 12, the S/R module 310 may then display the search results 328 in a list. More specifically, the S/R module 310 may display the search results 328 using a web page 330 in a web browser. The S/R module 310 may list the search results based on a priority order set by the search engine 302. In other words, the search engine 302 may output the search results in a predetermined order, wherein the S/R module 310 does not rearrange the search results, but presents them in the order received.

Each search result 328 includes identifying information 330, which allows a user to select an appropriate media file. This identifying information 330 may include a title 332, a location link 334, and a time bar 336. The title 332 allows a user to identify a search result. The title 332 may be a title of the media file or a title of a web page where the media file may be located. The location link 334 identifies a location the media record in the database 306. Upon selection by a user, the S/R module 310 may send a signal to the MP module 312 to receive a copy of the media record file.

Still referring to FIG. 12, the time bar 336 may depict a playback time or length of a particular media file. The time bar 336 may include at least one graphic indicator 318, such as a symbol, hash mark, or any other indicator used to identify a search term occurrence on the time bar 336. The graphic indicator 318 may indicate an instance within the playback time, which can be associated with at least one search term found within the associated media record file.

The time bar 336 may also include a graphic indicator number 338, which identifies the number of graphic indicators 318 included within the playback time. The graphic indicator number 338 may allow a user to quickly identify which media file includes a maximum number of terms associated with the search query. For example, if a search term is found twenty-one (21) times within a particular media file, the time bar 336 would include twenty-one (21) graphic indicators 318 along with the graphic indicator number 338 twenty-one (21) to indicate that twenty-one graphic indicators exist 318 along the time bar 336.

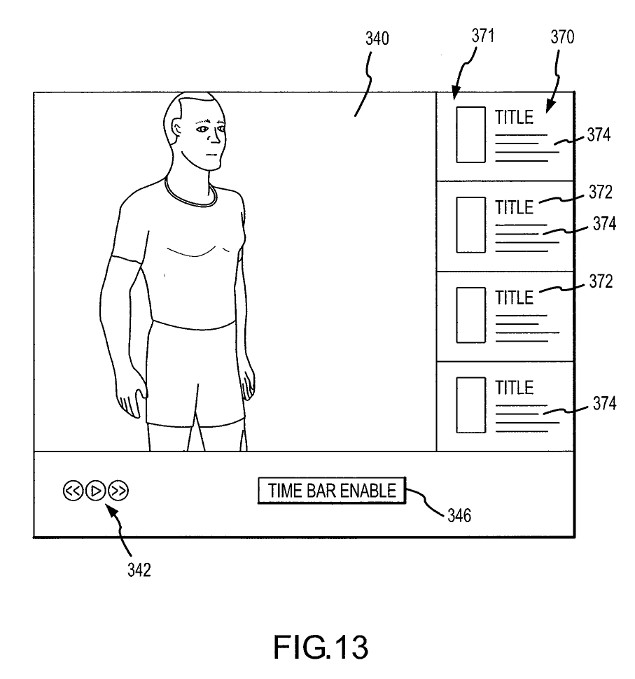

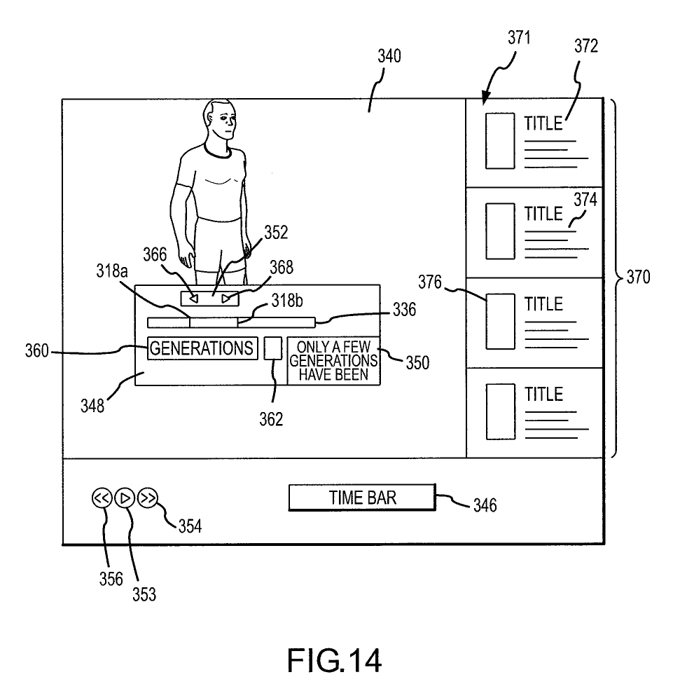

FIG. 13 is a diagrammatic view of an exemplary media file displayed by a MP module of the system in FIG. 10. FIG. 14 is a diagrammatic view of an exemplary time bar 336 having a plurality of graphic indicators.

Referring to FIGS. 10 and 13, once the user selects at least one of the search results 328 listed within the search results 328, the S/R module 310 may activate the MP module 312. The MP module 312 retrieves the selected media record file along with its associated time bar 336 from the database 306. When loading the selected media record file, the MP module 312 may load the text portion or header prior to the media. On advantage to loading the header first is that the time bar 336 associated with the media record file may be updated prior to the media portion being loaded. This allows a user to quickly identify the location of the search terms. The MP module 312 may present the selected media record file to a user, either by initiating playback of the file or displaying a still frame from the file.

The MP module 312 may include (or generate, control, or display) a visual pane area 340, a playback control tool bar 342, a time bar 344 or search enable button 346, the time bar 336, a search pane area 348, a transcript display pane area 350, and a scroll bar 352. If the media record file includes a video file, the video may be displayed in the video pane area. If the media file is an audio file, visualization or a simple playback indicator may be displayed in the visual pane area. The playback control tool bar 342 may allow a user to interact with one or more playback controls to control the selected media file. The playback controls 342 may include, for example, a play control 353 to initiate playing of the file, a pause control, a fast forward control 354, a rewind control (or reverse control) 356, and so on. The time bar enable button 346 may allow a user activate or deactivate the time bar 336. For example, if the time bar 336 is not currently displayed, a user may press the time bar 336 enable button to display the time bar 336. On the other hand, if the time bar 336 is being displayed, the user may press the time bar enable button 346 to hide the time bar 336.

Referring to FIG. 11, 13, and 14, the MP module 312 may also display a time bar 336 similar to that initially shown by the S/R module 310 in the search results list. For example, the time bar 336 displayed by the MP module 312 may include least one graphic indicator 318. Upon selection, the MP module 312 may shift playback of the selected media file to or near the time corresponding to the selected graphic indicator 318. For example, a media record file may have a playback time of 5 minutes. Referring to FIGS. 11 and 14, a search conducted, using the user inputted search query, may have identified two instances in the text portion of the media record file that is equal to a search query term. The search query terms are shown in bold letters 358 in the exemplary fragmented portion 320 of a transcript or text portion of the media record file of FIG. 11. In this example, the search terms appear two times within the text. The text includes a time mark based on a predetermined number of characters.

Again referring to FIGS. 11 and 14, an example is provided to further illustrate this point. For this example, a time mark 314 is associated for every 80 characters of text. There are two search query terms found within this file. Corresponding to the two search terms and their associated time mark, there are two graphic indicators 318 a first graphic indicator 318a at zero seconds and a second graphic indicator 318b at one minute, two seconds. The graphic indicator 318 may be positioned at the beginning of a time mark 314 that includes the search term. In this manner, the graphic indicator 318 generally corresponds to a time mark 314 in the text file header of the media record file and thus ensures that, when a user selects a given graphic indicator 318, the media file playback is placed at or near the occurrence of the search term in the media.

If a user selects the first graphic indicator 318a, playback of the media may be jumped to the beginning of the first time mark 314a. If the user selects the second graphic indicator 318b, playback of the media may be jumped to the beginning of the second time mark 314b. Thus, the media record file plays, in accordance with a user command, at or about an occurrence of the search term. Beginning at the selected graphic indicator 318, the MP module 312 may continue to play the media record file to the end 326 of the file, until the play time lapses, or until a command is received by the user to initiate a stop function.

Referring to FIG. 13, the search pane area 348 may include a search box 360 and a search button 362 to aid in conducting the search. The search box 360 may allow a user to input keywords or search query terms. The search query terms may be used to search the text portion of the selected media record file. The search box 360 may be a textual field with a maximum length of characters. For example, the maximum length of characters may include 50 characters.

Still referring to FIG. 14, the transcript display pane 350 may allow a user to observe the transcript as the media is being played. More specifically, since the text file is synchronized with the media file, the text file may be scrolled in the transcript display pane. The transcript display pane 350 may include a text box 364 to view the transcript. The text box 364 may include a textual field, with a maximum length of characters to be displayed. For example, the transcript display pane 350 may only exhibit 100 characters of the transcript at any time.

The scroll bar 352 may include a graphical device to allow a user to navigate among graphical indicators 318 within the time bar 336. For example, the scroll bar 352 may include a left-facing arrow 366 to move from one graphical indicator to a previous graphical indicator or a right-facing arrow 368 to move from the one graphical indicator to a next graphical indicator.

Referring to FIGS. 13-14, the MP module 312 may also provide, generate or display a listing of media information 370 related other media record files stored in the database 306. The media information 370 may be displayed in a display section or pane 371 of the visual pane 340. The media information 370 may include a title 372, a description 374, and a thumbnail image 376 that represents a media record file. The media information may be displayed in any order. A preferred order of display may include the title 372 located at a top 378 of the display pane 371, the description located on a right side of the display pane 371, and the thumbnail image 376 located on a left side of the description 374. If a user selects media information 370 related a media record file, the MP module 312 loads the header prior to the media in order to quickly update the time bar 336.

In another embodiment, the time bar 336 may also list each search term found in the text portion of the media record file. More specifically, the time bar 336 may include a display pane 382 that displays a listing of search terms found in the text file or each search term associated with a graphic indicator 318 on the time bar 336. Along with the listing of search terms, the display pane 382 may also display an associated time mark or instance where the search terms are found in the playback time of the media file. The search terms may also be listed with surrounding text, such that a user may quickly discern the search terms in the context of which they are spoken within the media file.

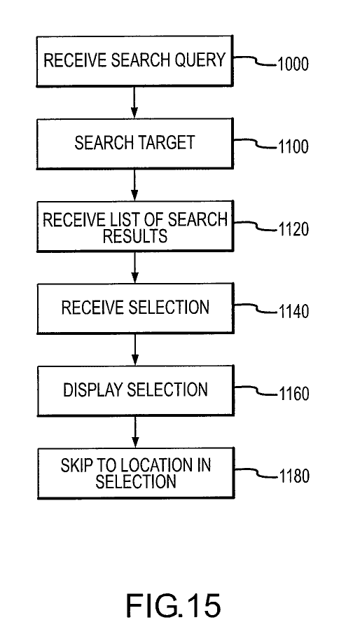

The following paragraphs describe a method used by the system of the present invention. FIG. 15 is a flow chart of the method used by the system in FIG. 10 of the present invention.

Beginning with operation 1000 of FIG. 15, a search query is retrieved. More particularly, the user inputs the search query using the user interface tool 308. The S/R module 310 outputs the search query to the search engine 302. In operation 1100, the search engine 302 searches a target to retrieve information on related media files based on the search query. The target may include a database 306 which includes indexes of information related to media record files which includes a header having a transcript of associated media file a text. If the search engine 302 finds any media record files related to the search terms, the search engine 302 retrieves and outputs the search results to the S/R module 310.

At operation 1120, the S/R module 310 receives the search results found by the search engine 302. The search engine 302 may find search results related to one or more media record files. In operation 1140, the S/R module 310 displays the search results in a list, such that each search result includes the title, the associated time bar 336, a location link, and an associated picture file, if available. The time bar 336 displays at least one graphic indicator 318 to indicate at least one instance where the search term is disclosed in the transcript. The time bar 336 may display the graphical indicator number, which identifies the number of graphic indicators displayed on the time bar 336. The user selects one of the media files listed. In response thereto, the S/R module 310 send a signal to the MP module 312 to activate and retrieve the selected media record file.

The MP module 312 retrieves the selected media record file and the associated time bar 336 from the database 306. The header is first loaded by the MP module 312, then the media is loaded. The MP module 312 displays the selected media file along with its associated time bar 336 and graphic indicators. The user selects one of the graphic indicators located on the time bar 336. In operation 116, the MP module 312 receives a time mark or graphic indicator command associated with a selected graphic indicator 318. The time mark command skips or increments the media file at or about the instance of the associated graphic indicator is location within the playback time, in operation 1180.

Although the present invention has been described with reference to preferred embodiments, persons skilled in the art may recognize that changes may be made in form and detail without departing from the spirit and scope of the invention.

What is claimed is:

1. A method for presenting a media file comprising:
receiving a request to retrieve at least one media file associated with a first search;
retrieving at least one media file; and
displaying the at least one media file;
displaying a time bar indicating a playback time associated with the at least one media file, wherein
the time bar includes at least one graphic indicator marking a location within the media file of a search term.

2. The method of claim 1, further comprising:
receiving a selection request for the at least one media file; and
displaying a selected media file and associated time bar in a media presentation module configured to play the selected media file.

3. The method of claim 1, further comprising: receiving a user-inputted request to jump the media file to a particular instance within the playback time that is associated with the at least one graphic indicator.

4. The method of claim 1, wherein the operation of displaying the at least one media file along with the time bar comprises displaying the at least one media file and the time bar in one of a plurality of user selectable languages.

5. The method of claim 1, wherein the operation of retrieving the at least one media file comprises listing at least one descriptive datum related to the at least one media file.

6. The method of claim 5, wherein the operation of listing the at least one descriptive datum comprises listing a total playback time of the at least one media file.

7. The method of claim 1, further comprising: receiving a text file associated with the at least one media file.

8. The method of claim 7, further comprising: appending the text file to the media file as a header.

9. The method of claim 1, further comprising: expanding a first tab of a plurality of tabs in a toolbar, the first tab configured to facilitate a request to retrieve the at least one media file.

10. The method of claim 9, further comprising: expanding a second tab of the plurality of tabs in the toolbar, the second tab configured to facilitate connecting a user to a community in order to communicate with other users within the community.

11. The method of claim 9, further comprising: expanding a second tab of the plurality of tabs in the tool bar, the second tab configured to facilitate automatically receiving resources associated with a second search that is based on user selectable preferences.

12. The method of claim 9, further comprising: expanding a second tab of the plurality of tabs in the tool bar, the second tab configured to facilitate displaying at least one of a plurality of user selectable preferences.

13. A system for presenting a plurality of media files comprising:
a database having a plurality of records, each record corresponding to a media file;
a retrieval module in communication with the database and configured to retrieve and display at least one media file related to a search query, and further configured to generate a time bar associated with the at least one media file, the time bar comprising at least one graphical indicator indicating a location of the search query in the media file.

14. The system of claim 13, further comprising:
a media presentation module in communication with the retrieval module and configured to receive a command to play the at least one media file.

15. The system of claim 14, wherein the media presentation module is further configured to display the at least one media file and the time bar along with the at least one graphical indicator.

16. The system of claim 14, wherein the media presentation module is further configured to play the at least one media file at the location of a selected graphical indicator.

17. The system of claim 14, wherein the media presentation module is further configured to receive a user-inputted request to jump the media file to a location of the search query.

19. The system of claim 13, wherein the retrieval module is further configured to list at least one descriptive datum related to the at least one media file.

20. The system of claim 19, wherein the at least one descriptive datum comprises a total playback time of the at least one media file.

21. The system of claim 19, wherein each media file comprises a media segment and a text header appended to the media segment.

22. The system of claim 21, wherein each text file comprises a plurality of character blocks; and a plurality of time marks, each time mark corresponds to one of the plurality of character blocks, wherein each time marker is located at a beginning of each character block.

23. The system of claim 22, wherein the media presentation module is further configured to play the media file at a beginning of a block of characters of the text file where the search query is located.

24. The system of claim 24, wherein the media presentation module is configured to load the header prior to loading the associated media file.

25. The system of claim 14, wherein the media presentation module and the retrieval module are implemented in a single module.

26. A toolbar comprising:
a first module configured for displaying user selectable preferences;
a second module in communication with the first module and configured to interact with a search engine to retrieve a first set of search results based on the user selectable preferences for displaying the search results to a user;
a third module in communication with the first module and configured to allow a user to communicate with at least one other user of a selection of other users based on the user selectable preferences; and
a fourth module in communication with the search engine and configured to retrieve a second set of search results for displaying to a user based on a user inputted search query for displaying to the user.

27. The toolbar of claim 26, wherein the second set of search results include at least one media file with an associated time bar, the associated time includes at least one indicator identifying a location of the search query within the at least one media file.

28. The toolbar of claim 27, wherein a text file is associated to the at least one media file.

29. The toolbar of claim 26, wherein the third module is further configured to display the selection of other users based on the user selectable preferences.

30. The toolbar of claim 26, wherein the first set of search results may include at least one of a media file, a web-conference file, or a video or audio download file.
